(19) United States
(12) Patent Application Publication
(10) Pub. No.: US 2007/0041733 A1
(43) Pub. Date: Feb. 22, 2007

(54) Polarization-diverse negative-refractive-index apparatus and methods

(76) Inventor: Aref Chowdhury, Berkeley Heights, NJ (US)

Correspondence Address: Michael J. Urbano, 1445 Princeton Drive, Bethlehem, PA, 18017-9166, US

(21) Appl. No.: 11/586,290

(22) Filed: Oct. 25, 2006

Related U.S. Application Data
(63) Continuation-in-part of application No. 10/835,753, filed on Apr. 30, 2004.

(51) Int. Cl. H04B 10/00

(52) U.S. Cl. 398/152; 398/3

(57) ABSTRACT

A polarization-diverse apparatus includes a polarization-sensitive negative-refractive-index (NRI) medium and a polarization splitter. The polarization splitter is configured to receive an electromagnetic input signal, to direct a first polarization component of the received input signal to a first path segment, and to direct a second polarization component of the received input signal to a separate second path segment. The medium has first and second signal ports. The first port is at an end of the first path segment. The second port is at an end of the second path segment. The medium outputs an altered signal from one of the ports in response to receiving the input signal at the other of the ports. In a preferred embodiment, the medium has an internal optical axis, and the polarizations of the first and second components are oriented relative to that axis so that effect of altering the input signal is enhanced. The two path segments may include polarization-maintaining waveguides.

### CROSS-REFERENCE TO RELATED APPLICATIONS

This application is a continuation-in-part of copending application Ser. No. 10/835,753 filed on Apr. 30, 2004 and entitled “Polarization-Diverse Wavelength Converter (A. Chowdhury 8-84-10).

### BACKGROUND

1. Field of the Invention

This invention relates generally to negative-refractive-index apparatus and methods and, more specifically, to polarization diversity in such apparatus/methods.

2. Discussion of the Related Art

Nearly four decades ago V. G. Veselago predicted that electromagnetic waves propagating at a particular frequency, or range of frequencies, in a medium having simultaneously negative permittivity and negative permeability would exhibit negative refractive index (NRI). [See, Sov. Phys. Usp., Vol. 10, p. 509 (1968), which is incorporated herein by reference.]

In the last decade researchers have reported experiments that proved the existence of such NRI media at microwave frequencies. [See, for example, J. B. Pendry, Phys. Rev. Lett., Vol. 85, p. 3966 (2000) and R. A. Shelby, et al., Science, Vol. 292, p. 277 (2001), which are incorporated herein by reference.]

According to A. Berrier et al., it was far from obvious that NRI would scale down to the optical domain. [See, Phys. Rev. Lett., Vol. 93, No. 7, pp. 073902 (2004), which is incorporated herein by reference.] Nevertheless, it was predicted that photonic crystals (PCs) could exhibit NRI without requiring both a negative permittivity and a negative permeability. This phenomenon was demonstrated in PCs at both microwave and optical frequencies. [Id. at 072902-1, col. 1.]

Additionally, it has been observed that many NRI media require that the electromagnetic wave propagate through it with a particular polarization. For example, Berrier et al., used a polarizer to ensure TM polarization in their PC. [Id. at 072902-2, col. 2.]

A problem arises, however, when polarization-sensitive devices, such as those including the aforementioned NRI media, are incorporated into certain types of systems. In fiber-optic communication systems, for example, propagating optical signals often arrive at network nodes with unknown polarizations. The polarizations of the arriving optical signals may vary unpredictably in time. The absence of a priori knowledge about the polarizations of the arriving optical signals makes it desirable to process such optical signals in a manner that is insensitive to polarization. For that reason, optical devices for processing optical signals are typically constructed to be polarization insensitive or independent; i.e., able to provide comparable performance regardless of the polarization of the input signal to the device. Similar comments apply to systems operating at non-optical frequencies (e.g., in the microwave band) as well as to some non-communications systems.

Thus, a need remains in the art for apparatus that delivers electromagnetic radiation of a suitable polarization to a NRI medium regardless of the polarization of an input signal to the apparatus.

### SUMMARY

Various embodiments provide polarization-diverse (PD) apparatus that causes two orthogonal polarization components of an input electromagnetic (EM) signal to propagate over the same transmission path. The apparatus includes a polarization sensitive (PS) medium that presents a NRI to both polarization components and at at least one frequency of the input signal. The apparatus is designed so that NRI is presented to both polarizations under substantially the same conditions. Since both polarization components propagate over the same transmission path and experience NRI under substantially the same conditions, this apparatus has higher stability against changes to environmental conditions.

In accordance with one aspect of our invention, an apparatus includes a PS NRI medium and a polarization splitter. The polarization splitter is configured to receive an input EM signal, to direct a first polarization component of the received input signal to a first transmission path segment, and to direct a second polarization component of the received EM signal to a separate second transmission path segment. The PS NRI medium has first and second ports. The first port is at an end of the first transmission path segment. The second port is at an end of the second transmission path segment. The PS NRI medium outputs an EM signal from one of the ports in response to receiving part of the input signal at the other of the ports, and conversely.

In a preferred embodiment, the PS NRI medium has an internal axis (IA), and the polarizations of the first and second components are oriented relative to the IA so that they enhance NRI effects on the components. In another embodiment, the first and second transmission path segments include polarization-maintaining waveguides.

In accordance with another aspect of our invention, a method provides steps for PD processing of EM signals propagating in a transmission path. The steps include splitting an input EM signal into orthogonal first and second polarization components, transmitting the first polarization component of the input signal to a first end of the transmission path, and transmitting the second polarization component of the input signal to the second end of the transmission path. The transmission path comprises a path segment having a NRI medium; that is, it includes a PS NRI medium having an IA that is a preferred for enhancing NRI effects. Preferably, the polarizations of the two components are oriented relative to the IA so as to enhance such NRI effects. The steps also include recombining the EM signal output at the two ends of the transmission path in response to the acts of transmitting. In one embodiment, the transmission path may be viewed as a tandem arrangement of the first path segment, the NRI-medium-containing path segment and the second path segment.

### BRIEF DESCRIPTION OF THE DRAWINGS

FIG. 1 is a schematic block diagram of polarization diverse (PD) apparatus including a NRI medium;

FIG. 2 is a flow chart for a method of operating apparatus including a PD NRI medium, e.g., the PD NRI apparatus of FIG. 1, 3 or 4;

FIG. 3 is a schematic block diagram of another embodiment of PD apparatus including a NRI medium; and

FIG. 4 is a schematic block diagram of yet another embodiment of PD apparatus including a NRI medium.

In the figures and text, like reference numbers refer to functionally similar features.

Herein, various embodiments are described more fully with reference to accompanying figures and description. The invention may, however, be embodied in various forms and is not limited to the embodiments described herein.

### DETAILED DESCRIPTION OF ILLUSTRATIVE EMBODIMENTS

Negative Refractive Index Devices in General

When Veselago, supra, first proposed NRI media nearly forty years, he theorized the existence of NRI behavior in gyrotropic substances possessing plasmas and magnetic properties; that is, the substances should contain both (i) sufficiently mobile carriers to form an electron-hole plasma and (ii) a system of interacting spins that provide a large magnetic susceptibility. NRI was predicated, however, on the requirement that the substance exhibited both a negative permittivity and a negative permeability. With these constraints Veselago indicated the possibility of NRI behavior in ferromagnetic substances (e.g., Ni) and semiconductors (e.g., CuFeS₂, UTe₂, and InSb—FeSb). [See, Veselago, supra, at 513, col. 2.] At the time, however, Veselago did not describe whether NRI in such substances was related to the polarization of the EM wave propagating therein.

Much later D. R. Smith et al. demonstrated a current source radiating into a composite medium composed of an array of metal posts interspersed with an array of split ring resonators. This medium exhibited both a negative effective permittivity and a negative effective permeability, as well as NRI within certain ranges of the frequency of an EM wave propagating therein. [See, D. R. Smith et al., Phys. Rev. Lett., Vol. 85, No. 14, p. 2933 (2000), which is incorporated herein by reference.]

In the same year Pendry, supra, proposed a class of superlenses that utilized a slab of NRI material to focus EM radiation onto an area smaller than a square wavelength. He stated that such superlenses could be realized at microwave frequencies with then available technology (e.g., a metal wire structure with lattice spacing of the order of a few millimeters that would behave like a plasma with a resonant frequency in the GHz region). In addition, Pendry simulated superlens operation within certain optical frequency ranges for S-polarized light and P-polarized light. Interestingly, he postulated that for P-polarized waves the dependence of NRI on negative permeability is eliminated, and only the permittivity is relevant. [See, Pendry, supra, at 3968, col. 2.]

In 2004 Berrier et al., supra, reported experimental evidence of NRI at telecommunication wavelengths (e.g., 1.5-1.7 μm) in a two-dimensional PC device. The PC included a triangular lattice of air holes formed in a low-index contrast InP/GaInAsP/InP slab. Light was coupled into the device through a polarization-maintaining fiber, and a polarizer ensured TM polarization.

In 2006 A. Chowdhury et al. described PS nonlinear optical devices based on metamaterials; that is, media that have a NRI in some wavelength range. Illustratively the device is a wavelength converter that includes an optical medium that behaves as a NRI at infrared or visible wavelengths. The optical medium includes a stack of substantially identical layers. Each layer includes a regular two-dimensional (2D) planar array of metallic structures and transparent planar dielectric layers. Each 2D array may function, for example, as an optical inductive-capacitive circuit. In the stack, different layers are aligned so that the medium has a periodic three-dimensional lattice symmetry. [See, A. Chowdhury et al., U.S. patent application Ser. No. 11/432,803 filed on May 13, 2006 (A. Chowdhury 15-1), which is incorporated herein by reference.]

In summary, it is clear from the prior art that devices can be made to exhibit NRI provided that the EM wave propagating therein has a particular frequency, which is within a certain frequency range, and has a particular polarization, which depends on the design of the device. For simplicity, we describe below polarization diversity (PD) schemes for operation at optical frequencies, but those skilled in the art will recognize readily that the principles set forth are applicable to other frequency bands (e.g., microwave) as well.

Polarization Diverse NRI Embodiments

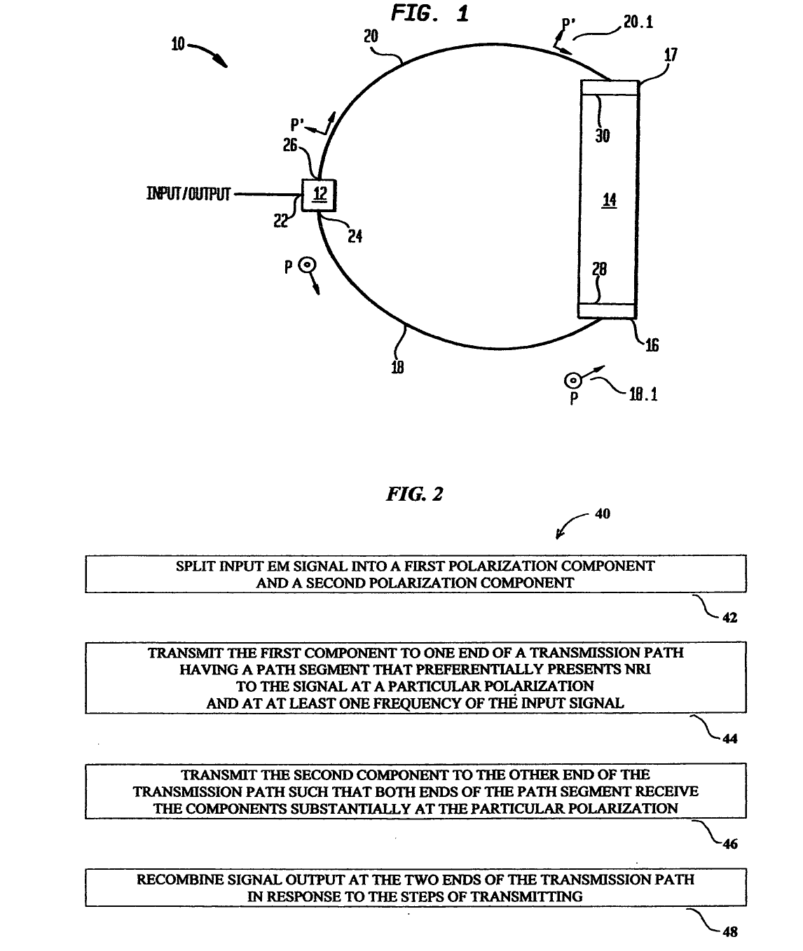

The description of FIGS. 1-4 that follows discusses various embodiments of PD apparatus and methods incorporating NRI media. Such apparatus and/or methods may find diverse applications ranging from communication systems to biological systems. Communication systems may involve the use of waveguides (e.g., optical fibers, planar waveguides) or free-space links (e.g., between satellites), or both. Other possible applications include lithography, imaging and signal processing, for example.

In addition, the EM input signal of the various embodiments described below may represent a single channel (e.g., at a single carrier center frequency) or multiple channels (e.g., multiple carriers at different center frequencies, as in a WDM system).

FIG. 1 shows an apparatus 10 that is configured to produce polarization-diverse (PD) operation on light propagating in an optical path formed by first and second path segments (e.g., waveguides 18, 20) optically coupled to one another by a third segment that includes a NRI medium. More specifically, the PD-apparatus 10 includes a polarization splitter 12; a polarization-sensitive NRI medium or device 14 (either linear or nonlinear; hereinafter simply referred to as NRI medium 14); polarization rotators 16, 17; and first and second optical waveguides 18, 20 optically coupled to a source of an input signal to be operated on. The polarization sensitivity of NRI medium 14 implies that a particular polarization is preferentially affected more than other polarizations, as discussed more fully hereinafter.

Illustratively, the medium 14 may be any polarization sensitive device that presents a NRI to an optical signal propagating therethrough and thereby produces an effect on the optical signal. Such devices include all of those described in the foregoing section, as well as many others well-known to those skilled in the art.

By having an effect on a signal we mean that the presence of NRI in the medium, in general, causes the directions of the phase velocity and group velocity of an EM signal propagating therein to be opposite to one another in the NRI medium; and, in particular, may alter, modulate or otherwise change (i) one or more parameters (e.g., amplitude, frequency or phase) of the EM signal, or (ii) a spatial characteristic (e.g., focus or collimation) of the signal, or both (i) and (ii). Hereinafter, we truncate the phrase “alters, modulates or otherwise changes” to “alters” in the interests of simplicity.

Note that polarization splitter 12 receives input signal light of arbitrary polarization at optical port 22 and splits the received signal light into orthogonal plane-polarization components 18.1, 20.1. The polarization splitter 12 outputs one plane-polarization component 18.1 of the received light to optical waveguide 18 via optical port 24 and outputs the other plane-polarization component 20.1 of the received light to optical waveguide 20 via optical port 26. Exemplary polarization splitters 12 include Nicol, Rochon, Glan-Thompson, and Wollastan prisms, planar waveguide polarization splitters, and other optical polarization splitters known to those of ordinary skill in the art.

PS-NRI medium 14 is typically incorporated in an optical waveguide that connects optical port 28 to optical port 30. Exemplary optical waveguides include a relatively high refractive index region, which is located in a bulk, planar, or buried structure of an optical medium (e.g., a semiconductor or silica). The PS-NRI medium 14 has an optical port 28, 30 at each end of the internal optical waveguide, which is adapted to operate on optical signals entering these ports to produce a desired effect predicated, at least in part, upon the NRI characteristic of medium 14. As mentioned previously, the desired effect illustratively alters one or more parameters or spatial characteristics of the optical signal propagating through medium 14. For that reason, the PS-NRI medium 14 will output altered signal light from either optical port 28, 30 in response to the other optical port 30, 28 receiving input light.

The PS-NRI medium 14 has an internal optical axis (IOA). If the (linear) polarization of the input signal light is oriented at a preferred angle α relative to the IOA, the desired effect is most efficient. Depending on the design of the PS-NRI medium 14, α might be zero, in which case polarization of the input light is preferably substantially parallel to the IOA; or α might be 90°; in which case the polarization of the input light is preferably substantially perpendicular to the IOA; or α might have a value αₒ between these two extremes, in which case the polarization of the input light is preferably oriented at the angle αₒ relative to the IOA. Hence, we refer to any linear polarization oriented at an angle α to the IOA as being preferred. For that reason, the PS-NRI medium 14 is not a polarization-independent optical device; rather, it is polarization sensitive or dependent. Illustrations of the IOA include the direction substantially perpendicular or parallel to the layers of medium 14, or the direction substantially parallel to the axis of symmetry of a PC. However, depending on the details of their designs, these devices may alternatively have IOAs that are oriented neither parallel nor perpendicular to the particular layers or axes discussed above.

For simplicity in the description of FIGS. 1, 3 and 4 that follows, we will assume that α=0 and that the polarizations of the input signal light components are oriented substantially parallel to the IOA of PS-NRI medium 14 as they enter PS-NRI medium 14.

PD apparatus 10 includes features that compensate for the polarization-dependent character of PS-NRI medium 14.

First, optical waveguides 18, 20 and polarization rotators 16, 17 are configured to deliver light to both optical ports 28, 30 so that the polarizations of the input light components 18.1, 20.1 are preferably substantially parallel to the IOA of PS-NRI medium 14 upon entering PS-NRI medium 14. The optical waveguides 18, 20 may be specifically configured to maintain the plane polarizations P, P′ received via optical ports 24, 26 of the polarization splitter 12. For example, the optical waveguides 18, 20 may be polarization-maintaining optical fibers (PMFs). In preferred embodiments, the PMFs are also oriented to deliver light to optical ports 28, 30 such that the light components are polarized substantially along the IOA of the PS-NRI medium 14. In such embodiments, the polarization rotators 16, 17 are absent. In other such embodiments, the PMFs have transverse optical axes that are oriented to launch non-optimally polarized light components toward the ends of PS-NRI medium 14. In such embodiments, the polarization rotators 16, 17 rotate plane polarizations P, P′ of the launched light so that the polarizations are substantially parallel to the IOA of the PS-NRI medium 14 at the optical ports 28, 30.

Exemplary polarization rotators 16, 17 are suitably oriented half-wave plates, optically active media, obliquely oriented mirror pairs, or other well-known polarization rotators.

Typically, the first and second polarization rotators 16, 17 produce relative rotations of approximately 90° so that light is delivered to both ends of the PS-NRI medium 14 with substantially the same polarization, e.g., the optimal, preferred polarization for producing the desired effect on the optical signal propagating therein. (In fiber optic applications, in lieu of rotators 16, 17 polarization rotation may also be effected by simply axially twisting at least one of the fibers so that there is a 90° difference in polarizations between the two fibers, and so that the polarizations entering ports 28, 30 of PS-NRI medium 14 are substantially parallel to its IOA.) It is clear, therefore, that polarization rotators may be used in pairs, as shown in FIG. 1, may be used singly in only one of path segments, or may be omitted altogether, depending on the particular design of the PD-apparatus.

Alignment errors between the polarizations of the input light and the IOA of the PS-NRI medium 14 are 10° or less, preferably are 5° or less, and more preferably are 1° or less.

In PD-apparatus 10, optical port 22 receives input light and transmits output light. Both polarization components travel the same optical paths, albeit in opposite directions. Both polarization components undergo NRI-altering effects under substantially the same conditions; i.e., experiencing substantially the operation and preferably having substantially the same polarization orientations in PS-NRI medium 14. For these reasons, PD-apparatus 10 has a relatively low sensitivity to changes in environmental conditions.

FIG. 2 illustrates a method 40 of processing EM signals propagating in a transmission path in a polarization-diverse manner, e.g., in a PD-apparatus 10, 10′, 10″ of FIG. 1, 3, or 4, respectively. As discussed previously, we assume for purposes of illustration and simplicity only that the EM signal is an optical (light) signal. As such, the transmission path illustratively includes a tandem arrangement of optical path segments; i.e., first and second path segments (e.g., waveguides 18, 20) optically coupled to one another by a third optical segment that includes a NRI medium (e.g., PS-NRI medium 14). In general, Step 42 of method 40 includes splitting received input signal light into a first plane-polarization component and an orthogonal second plane-polarization component. The first component has a linear polarization that is orthogonal to a linear polarization of the second component. Step 44 of the method 40 includes transmitting the first polarization component of the received light to a first end of the optical transmission path. The transmission path includes a polarization-sensitive path segment for producing a NRI-altering effect in the light signal at a particular polarization and at at least one particular frequency of the input signal (or within at least one range of input signal frequencies). The path segment includes a PS-NRI medium that is adapted to alter the light input signal, e.g., as in PS-NRI medium 14 of FIGS. 1, 3, and 4. Step 46 of method 40 includes transmitting the second polarization component of the received light input signal to the second end of the same optical transmission path and simultaneously transmitting the first polarization component to the first end. Furthermore, the transmitting steps preferably cause the two polarization components of the light input to have substantially parallel polarization states in the PS-NRI path segment.

In some embodiments, polarizations of one or both components are rotated prior to insertion into the PS-NRI path segment to align their polarizations in the path segment (e.g., within the PS-NRI medium 14). In some embodiments, one or both components are sent through suitably aligned polarization-maintaining optical waveguides to cause the polarizations of the two components to be substantially parallel to one another in the PS-NRI path segment and substantially parallel to a particular, preferred orientation for producing an optimum desired effect (e.g., preferably substantially parallel to the IOA of PS-NRI medium 14).

Step 48 of method 40 includes recombining light signals that are outputted (i.e., egress) from the two ends of the optical transmission path in response to the steps of transmitting. The recombined light signal constitutes an altered light signal. In the recombined signal, the intensity and quality of the altered light are substantially independent of the polarization of the original input signal light so that the method 40 is polarization-diverse. Method 40 remains polarization-insensitive as environmental conditions change due to two features. First, both polarization components traverse substantially the same optical transmission path between the steps of splitting and recombining. Second, both polarization components undergo NRI-induced alteration under substantially the same conditions.

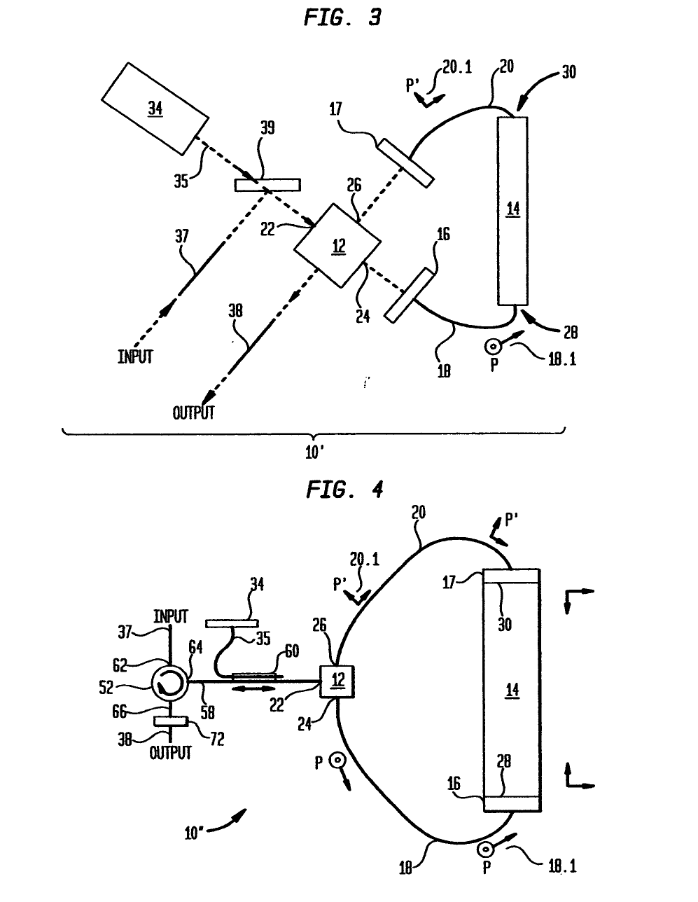

Note, when method 40 is applied to embodiments of our invention that employ longitudinal pumping of PS-NRI medium 14, such as those shown in FIGS. 3-4 and described below, then step 42 involves splitting both the input light signal and the pump light signal into first and second polarization components and step 48 involves recombining both the altered light signal and the pump light signal.

FIGS. 3 and 4 show longitudinally pumped embodiments of PD-apparatuses 10′, 10″ for applications that require a pump. The applications may involve processes that are either linear or nonlinear. Thus, in these embodiments the pump source takes the form of a pump laser source 34 whose output is longitudinally coupled into PS-NRI medium 14 via an arrangement of suitable optical components described below.

FIG. 3 shows a PD-apparatus 10′ that is polarization-diverse. The PD-apparatus 10′ includes polarization splitter 12; PS-NRI medium 14; pump laser source 34 optically coupled to PS-NRI medium 14; Faraday optical rotators 16, 17; and preferably polarization-maintaining optical fibers (PMFs) 18, 20 as already described with respect to PD-apparatus 10 of FIG. 1. Here, the optical rotators 16, 17 rotate polarizations of light received from the polarization splitter 12 by 45° up to rotation errors of 5° or less and preferably of 1° or less. The optical rotators 16, 17 transmit the polarization-rotated light to PMFs 18, 20. The PMFs are oriented to maintain the polarizations of the light incident thereon. The PMFs 18, 20 are also oriented to deliver the light to optical ports 28, 30 of PS-NRI medium 14 so that the polarizations of the delivered light are oriented substantially along the IOA of the PS-NRI medium 14.

PD-apparatus 10′ also includes pump laser source 34, pump optical fiber 35, input optical fiber 37, output optical fiber 38, and dichroic slab 39. The pump laser source 34 produces pump light for use in producing a desired effect on light propagating through PS-NRI medium 14. The pump optical fiber 35 is a PMF that delivers pump light to the dichroic slab 39 with a selected polarization. The input optical fiber 37 delivers input light to the dichroic slab 39. The dichroic slab 39, which may, for example, be a thin film device, selectively transmits light at the wavelength of the pump laser source 34 and selectively reflects light at the wavelength of the input light. That is, the dichroic slab 39 is configured to direct both the pump light and the input light toward optical port 22 of polarization splitter 12.

In one embodiment, the pump optical fiber 35 is oriented to emit pump light whose polarization makes an angle of 45°±5° or 45°±1° with respect to the internal optical axis of the polarization splitter 12 at optical port 22. For that reason, the polarization splitter 12 transmits substantially the same intensity of pump light to each optical port 24, 26. Since the optical fibers 18, 20 are oriented to maintain polarizations of light received from the optical rotators 16, 17, these optical fibers 18, 20 deliver received pump light intensities to optical ports 28, 30 without substantial attenuation. Since each optical fiber 18, 20 receives substantially the same intensity of pump light, the optical fibers 18, 20 deliver substantially the same pump light intensity to each optical port 28, 30 of PS-NRI medium 14.

The optical fibers 18, 20 close an optical loop between optical ports 24, 26. In the optical loop, the optical fibers 18, 20 deliver light received from the PS-NRI medium 14 to the optical rotators 16, 17 and thus to polarization splitter 12. Around the optical loop, an overall polarization rotation of about 90° occurs; i.e., due to the non-reciprocity of the Faraday effect in the optical rotators 16, 17. This polarization rotation causes the polarization splitter 12 to redirect light, which is received from the loop, to output optical fiber 38 rather than back to optical port 22.

In PD-apparatus 10′ different polarization components of input light do not co-propagate in PMF. In particular, pump optical fiber 35, which is a PMF, carries only pump light, and optical fibers 18, 20, which are also PMFs, carry only a single polarization component of the input light. In addition, because the light components travel essentially identical optical path lengths, the input light does not undergo significant polarization-mode dispersion (PMD) in the PD-NRI medium 10′. (Low PMD is also a characteristic of PD-apparatuses 10 and 10″.) Low or zero PMD is desirable in, for example, WDM optical communication networks operating at high data rates, because PMD can be a significant limitation on optical data transmission rates.

Some embodiments of PD-apparatus 10′ of FIG. 3 have additional improvements. For example, a dichroic slab may be inserted between the optical output of polarization splitter 12 and output optical fiber 38 in order to reject left over pump light. Also, the two optical Faraday rotators 16, 17 may be replaced by a single optical device that produces a rotation of about 90°. (The single 90° rotation device may be located anywhere between ports 26 and 30 or between ports 24 and 28.) Also, the polarization splitter 12 may be a walk-off crystal rather than the polarization splitter cube shown in FIG. 3. For such a polarization splitter 12, the Faraday optical rotators 16 and 17 may be replaced by a single Faraday optical rotator, because optical outputs 24, 26 can transmit light to different locations on the single Faraday optical rotator.

FIG. 4 shows a second apparatus 10″ that is polarization-diverse. The PD-apparatus 10″ includes a polarization splitter 12; a PS-NRI medium 14; optical rotators 16, 17; and PMFs 18, 20, as already described with respect to PD-apparatuses 10, 10′ of FIGS. 1 and 3. The PD-apparatus 10″ also includes optical circulator 52, pump laser source 34, pump fiber 35 coupled to optical waveguide 58 via an optical fiber coupler 60.

Optical circulator 52 has three, ordered, optical ports 62, 64, 66. The first optical port 62 receives input signal light from input optical fiber 37 of, for example, an optical communication network. The second optical port 64 transmits the input signal light to a first end of optical waveguide 58. The third optical port 66 transmits light received at the second optical port 64 to output optical fiber 38 of the optical communication network.

Pump laser source 34 transmits linearly polarized pump light to optical pump fiber 35, which in turn transmits the pump light to optical fiber coupler 60. The pump fiber 35 and the optical fiber coupler 60 are polarization-maintaining waveguides whose transverse optical axes are aligned to efficiently deliver linearly polarized pump light to optical waveguide 58.

Optical waveguide 58 is a polarization-maintaining optical waveguide, which connects the second optical port 64 of optical circulator 52 and optical fiber coupler 60 to optical port 22 of polarization splitter 12. The optical port 22 functions as both an optical input, which transmits input and pump light to the polarization splitter 12, and as an optical output, which receives a mixture of pump and altered light from the polarization splitter 12. The polarization-maintaining optical waveguide 58 has its transverse optical axis aligned to deliver pump light to optical port 22 so that the polarization splitter 12 splits the delivered pump light intensity substantially equally between optical waveguide 18 and optical waveguide 20.

Preferably the optical waveguides 18, 20 are also PMFs whose transverse optical axes are aligned to deliver substantially equal pump light intensities to each side of PS-NRI medium 14. One or two optical rotators 16, 17 may produce polarization rotations so that polarizations of light emitted from the optical waveguides 18, 20 are preferably substantially aligned with the IOA of PS-NRI medium 14 at optical ports 28, 30. The IOA of PS-NRI medium 14 may also be oriented so that both PMFs 18, 20 deliver light polarized substantially along that optical axis.

The optical waveguides 18, 20 also deliver light from the PS-NRI medium 14 to polarization splitter 12. Optical splitter 12 transmits the light, which is delivered to optical ports 24, 26, to optical port 22. From optical port 22, optical waveguide 58 transports light to second optical port 64 of optical circulator 52. From the second optical port 64, the optical circulator 52 transmits light to optical port 66, which connects to output optical fiber 38.

Some embodiments of PD-apparatus 10″ also include one or more band pass optical filters 72 inserted between the third optical port 66 of optical circulator 52 and output optical fiber 38 of the optical communication network. The band pass optical filter 72 removes light having a wavelength of the pump light. Then, the output optical fiber 38 of the optical communication network receives substantially only light at the wavelength of the altered signal, which is produced in PS-NRI medium 14.

Referring to FIGS. 3 and 4, PD-apparatuses 10′, 10″ are substantially insensitive to environmental conditions and are polarization diverse for two reasons. First, both polarization components circulate along the same optical path in the optical PD-apparatuses 10′, 10″. Second, input light is subject to substantially the same NRI-induced altering conditions in the optical PS-NRI media 14. In particular, pump light of substantially the same polarization and intensity is launched longitudinally into each end of PS-NRI medium 14. Furthermore, input light is launched into each end of the PS-NRI medium 14 with substantially the same polarization.

Other embodiments of the invention will be apparent to those skilled in the art in light of the specification, drawings, and claims of this application.

What is claimed is:

1. An apparatus comprising:
a polarization splitter configured to receive an input electromagnetic signal, to direct a first polarization component of the received input signal to a first transmission path segment, and to direct a second polarization component of the received input signal to a separate second transmission path segment; and
a polarization-sensitive medium having an internal axis, said medium exhibiting, at at least one frequency of said input signal, negative refractive index that alters said input signal, said medium having first and second ports, the first port being at an end of the first path segment, the second port being at an end of the second path segment, said medium being configured to output said altered signal from one of the ports in response to receiving the input at the other of the ports,
wherein said first and second paths are configured so that the polarizations of said first and second components are substantially parallel to one another upon entering said ports.

2. The apparatus of claim 1, wherein each of said first and second path segments comprises a polarization-maintaining waveguide.

3. The apparatus of claim 1, wherein said first and second path segments are configured so that the polarizations of said first and second components are oriented relative to said internal axis so as to enhance the effect of altering said components.

4. The apparatus of claim 3, wherein said first and second path segments are configured so that the polarizations of said first and second components are oriented substantially parallel to said internal axis.

5. The apparatus of claim 1, further including an optical source of pump energy, said source comprising at least one laser longitudinally coupled to said medium.

6. The apparatus of claim 5, wherein said polarization splitter is configured to receive pump light from said laser, to direct a first polarization component of the received pump light to said first path segment, and to direct a second polarization component of the received pump light to said second path segment, said first and second path segments being configured so that the intensities of said first and second pump light components are substantially equal upon entering said medium.

7. The apparatus of claim 1, wherein the negative refractive index of said medium alters a parameter of said input signal, said parameter including its amplitude, frequency or phase, and/or alters a spatial characteristic of said input signal, said characteristic including its focus or collimation.

8. The apparatus of claim 1, wherein said electromagnetic signal is an optical signal, said path segments comprise optical paths, and at least one of said path segments includes a Faraday rotator.

9. The apparatus of claim 8, wherein said optical path segments are configured to deliver polarized optical signals to said splitter such that the delivered polarized signals exit said splitter from a different optical port than an optical port of the polarization splitter that received the input signal.

10. An apparatus comprising:
a polarization splitter configured to receive input light, to direct a first polarization component of the received input light to a first optical path segment, and to direct a second polarization component of the received input light to a separate second optical path segment; and
a polarization-sensitive optical medium having an internal optical axis, said medium exhibiting, at at least one frequency of said input signal, negative refractive index that alters said input signal when suitable pumping energy is applied to said medium, said medium having first and second optical ports, the first port being at an end of the first optical path segment, the second port being at an end of the second optical path segment, said medium being configured to output altered light from one of the ports in response to receiving the input at the other of the ports;
wherein each of said first and second optical path segments comprises a polarization-maintaining optical waveguide; and
wherein said first and second optical path segments are configured so that the polarizations of said first and second components are oriented relative to said internal axis so as to enhance the effect of altering said components.

11. The apparatus of claim 10, wherein said first and second optical path segments are configured so that the polarizations of said first and second components are substantially parallel to said internal axis.

12. A method for altering an electromagnetic signal comprising the steps of:
splitting a received electromagnetic input signal into a first polarization component and a second polarization component;
transmitting the first polarization component to a first end of a transmission path having signal altering path segment, the path segment including a polarization-sensitive medium configured to preferentially alter an electromagnetic signal of a particular polarization; said medium exhibiting, at at least one frequency of said input signal, negative refractive index that alters said input signal;
transmitting the second polarization component to the second end of the transmission path;
said transmitting steps configured to orient the polarizations of the first and second components substantially parallel to the particular polarization; and
recombining signals output at the two ends of the transmission path in response to the acts of transmitting.

13. The method of claim 12, wherein the particular polarization is oriented at an angle α to an internal axis of the medium, and said transmitting steps are configured to orient the polarizations of the first and second components substantially at the angle α to said internal axis.

14. The method of claim 12, wherein the splitting step also splits received an electromagnetic pump signal into first and second polarization components and the transmitting steps transmit the first and second pump components to opposite ends of the altering path segment, so that the intensities of the pump components are substantially equal upon entering the altering path segment.

15. The method of claim 12, wherein the transmission path includes a polarization-maintaining waveguide between its first end and the altering path segment and the transmission path includes a polarization-maintaining waveguide between its second end and the altering path segment.

16. The method of claim 12, wherein the negative refractive index of said medium alters a parameter of said input signal, said parameter including its amplitude, frequency or phase, and/or alters a spatial characteristic of said input signal, said characteristic including its focus or collimation.
